(19) United States
(12) Patent Application Publication
(10) Pub. No.: US 2005/0021947 A1
(43) Pub. Date: Jan. 27, 2005

(54) Method, system and program product for limiting insertion of content between computer programs

(75) Inventors: Ronald P. Doyle, Raleigh, NC (US); John R. Hind, Raleigh, NC (US); Marcia L. Stockton, Bakersfield, CA (US)

Correspondence Address: Jeanine S. Ray-Yarletts;IBM Corporation, T81/503, PO Box 12195, Research Triangle Park, NC, 27709, US

(73) Assignee: International Business Machines Corporation, Armonk, NY (US)

(21) Appl. No.: 10/455,068

(22) Filed: Jun. 5, 2003

(51) Int. Cl. H04L 9/00

(52) U.S. Cl. 713/164

(57) ABSTRACT

Under the present invention, one or more isolation zones are defined. Each isolation zone includes one or more computer programs grouped together, and can be defined manually by a user/administrator or automatically based on historical behavior. Once the isolation zone(s) are defined, a security prompt is displayed whenever an attempt is made to insert content across an isolation zone boundary. The security prompt can request confirmation by the user, or it can request a security credential before allowing the attempted content insertion.

### BACKGROUND OF THE INVENTION

1. Field of the Invention

The present invention generally relates to a method, system and program product for limiting insertion of content between computer programs. Specifically the present invention allows local computer programs to be assigned to one or more isolation zones. Once the isolation zone(s) are defined, insertion of content across zone boundaries is controlled.

2. Related Art

As computers become more advanced, they are increasingly becoming an everyday part of our personal and professional lives. Today, a computer user can pay bills, type a report, chat with a friend, etc. from a single computer system. In many instances, the computer user multitasks between personal and professional items. For example, it is common for a computer user to chat with a friend while performing a task for work. Unfortunately, with this increased convenience also comes heightened security concerns. Specifically, when simultaneously conducting personal and professional tasks, it is easy to accidentally insert/paste content into the wrong program. This can happen when a user copies content (e.g., a picture) from a particular program to a buffer (e.g., a clipboard), becomes distracted, and then forgets the content has been copied. Then, at a later time, the user may unsuspectingly insert that content into another program. For example, a user may copy a picture of his/her family with the intention of inserting it into an e-mail to his/her friend. After e-mailing his/her friend, the user might forget that the picture is still stored in the buffer and accidentally insert the same picture into an e-mail to his/her supervisor. Although the user could attempt to undo the insertion prior to sending the latter e-mail, he/she might inadvertently send the e-mail before doing so.

As can be seen, the ease with which content can be inserted across program boundaries can raise significant security concerns. For example, a user might inadvertently insert confidential business content into a non-business program. Still yet, a user might copy content to the buffer and then leave his/her work area. This could provide an unintended third party with the opportunity to access the content.

To date, several systems for passing data objects between applications have been developed. One such example, is the Windows Dynamic Data Exchange (DDE) API/protocol. This protocol is for passing data objects among conformant Windows applications, and has parameters on “cut-and-paste” so that only compatible TYPES of objects can be pasted from one application to another. However, the ability to cut and paste across Windows applications' boundaries is governed only by the object types that each application supports, rather than the security properties of the objects or applications, or the workflow in which they are used. To this extent, the protocol fails to provide a way to “zone” applications together, and then limit the passing of data objects across a zone boundary.

Another example is included in the Internet Explorer 5.5 and 6.0 web browsers. Specifically, these browsers provide security zones that associate a set of security policies with a set of web sites. This is to recognize that not all web sites are equally trustworthy. A set of security policies is generally a set of definitions for security-related configuration parameters controlling the browser's functionality. For example, a particular security policy could disallow the use of JAVA. Each security zone is defined by a set of security polices and a list of websites to which the set applies. Unfortunately, the security zone technology fails to provide security between computer programs implemented on a local computer system. Moreover, each website can only be associated with one security zone.

In view of the foregoing, there exists a need for method, system and program product for limiting insertion of content between computer programs. Specifically a need exists for a system that allows local computer programs to be assigned to isolation zones. The isolation zones can be defined manually by a user or administrator, or automatically based on a historical behavior. A further need exists for a security prompt to be provided when an attempt is made to insert content between the defined isolation zones.

### SUMMARY OF THE INVENTION

In general, the present invention provides a method, system and program product for inserting content between (local) computer programs. Specifically, under the present invention, one or more isolation zones are defined. Each isolation zone includes at least one computer program and/or file grouped together, and can be defined manually by a user/administrator or automatically based on historical behavior. In any event, once the isolation zone(s) are defined, a security prompt is provided whenever an attempt is made to insert content across an isolation zone boundary. For example, a security prompt is displayed when an attempt is made to insert (e.g., copy and paste) content from a source computer program of one isolation zone into a target computer program of another isolation zone. The security prompt can request confirmation by the user, or it can request a security credential before allowing the attempted content insertion.

A first aspect of the present invention provides a method for limiting insertion of content between computer programs, comprising: defining an isolation zone, wherein the isolation zone comprises at least one computer program; and providing a security prompt when an attempt is made to insert content across a boundary of the isolation zone.

A second aspect of the present invention provides a method for limiting insertion of content between local computer programs, comprising: defining a first isolation zone and a second isolation zone, wherein the first isolation zone and the second isolation zone each comprise at least one local computer program; and providing a security prompt when an attempt is made to insert content from a source computer program in the first isolation zone to a target computer program in the second isolation zone.

A third aspect of the present invention provides a system for limiting insertion of content between computer programs, comprising: a zone definition system for defining an isolation zone, wherein the isolation zone comprises at least one computer program; and an insertion limitation system for providing a security prompt when an attempt is made to insert content across a boundary of the isolation zone.

A fourth aspect of the present invention provides a program product stored on a recordable medium for limiting insertion of content between computer programs, which when executed comprises: program code for defining an isolation zone, wherein the isolation zone comprises at least one computer program; and program code for providing a security prompt when an attempt is made to insert content across a boundary of the isolation zone.

Therefore, the present invention provides a method, system and program product for limiting insertion of content between local computer programs.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for limiting insertion of content between computer programs according to the present invention.

FIG. 2 depicts an illustrative grouping interface for defining an isolation zone according to the present invention.

FIG. 3A depicts an illustrative desktop of icons for assigning individual programs to an isolation zone according to the present invention.

FIG. 3B depicts an illustrative file interface for assigning individual files to an isolation zone according to the present invention.

FIG. 4A depicts illustrative contact lists according to the present invention.

FIG. 4B depicts the grouping interface of FIG. 2 including a contact list from FIG. 4A.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system and program product for limiting insertion of content between (local) computer programs. Specifically, under the present invention, one or more isolation zones are defined. Each isolation zone includes at least one computer program and/or file grouped together, and can be defined manually by a user/administrator or automatically based on historical behavior. In any event, once the isolation zone(s) are defined, a security prompt is provided whenever an attempt is made to insert content across an isolation zone boundary. For example, a security prompt is displayed when an attempt is made to insert (e.g., copy and paste) content from a source computer program of one isolation zone into a target computer program of another isolation zone. The security prompt can request confirmation by the user, or it can request a security credential before allowing the attempted content insertion.

It should be understood in advance that when content is described as being “inserted” into a computer program is intended to mean that the content is “pasted,” “attached” or otherwise assimilated by a computer program. As known in the art, when content is cut or copied from a source computer program, it is typically stored in a buffer (commonly referred to as a clipboard). Once in the buffer, the content can then be inserted/pasted to a target computer program. To this extent, it should also be understood that when content is described herein as being “inserted” into a computer program, this includes the insertion of content into a window, interface or the like that corresponds to a computer program. For example, if content is described as being inserted into an electronic mailing program, this could mean that the content is actually “pasted” into a window corresponding to a new message being composed. Alternatively, it could mean that the image is “attached” to a new message. Still yet, as used herein, “computer program” is intended to mean any type of program (e.g., an application program, etc.) executable on a computerized system.

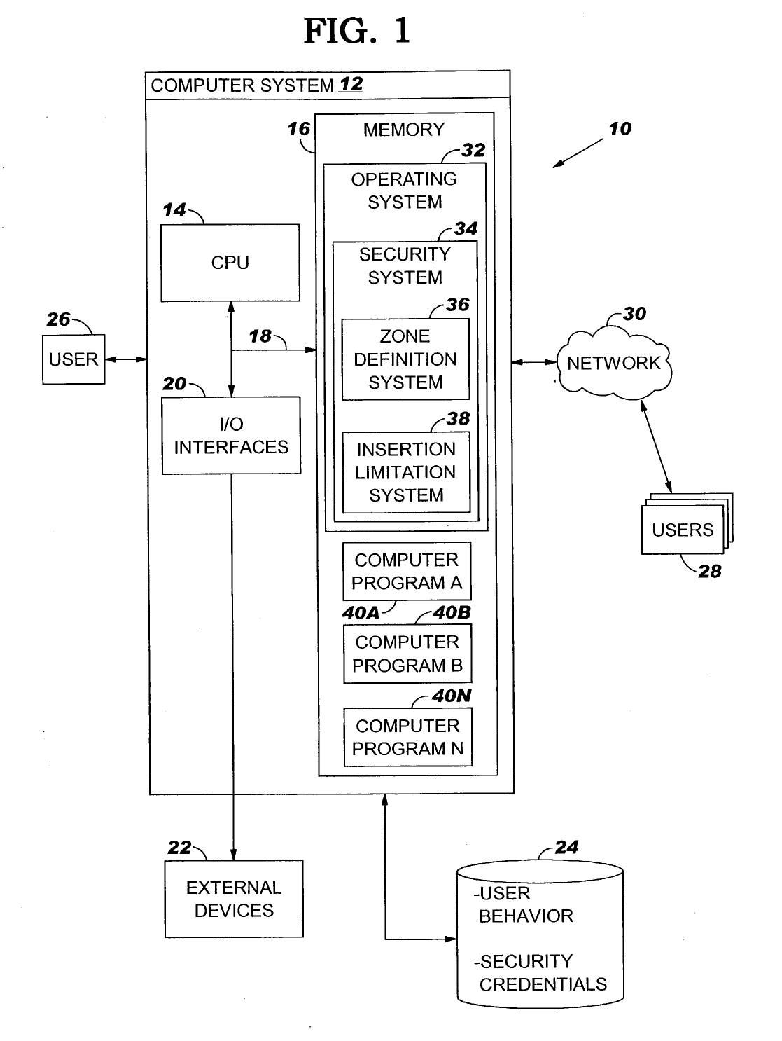

Referring now to FIG. 1, system 10 for limiting insertion of content between computer programs is shown. As depicted, system 10 comprises computer system 12, which generally includes central processing unit (CPU) 14, memory 16, bus 18, input/output (I/O) interfaces 20, external devices/resources 22 and storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to CPU 14, memory 16 may reside at a single physical location, comprising one or more types of data storage, or be distributed across a plurality of physical systems in various forms.

I/O interfaces 20 may comprise any system for exchanging information to/from an external source. External devices/resources 22 may comprise any known type of external device, including speakers, a CRT, LCD screen, hand-held device, keyboard, mouse, voice recognition system, speech output system, printer, monitor/display, facsimile, pager, etc. Bus 18 provides a communication link between each of the components in computer system 12 and likewise may comprise any known type of transmission link, including electrical, optical, wireless, etc.

Storage unit 24 can be any system (e.g., a database) capable of providing storage for information such as user historical behavior, security credentials, etc. under the present invention. As such, storage unit 24 could include one or more storage devices, such as a magnetic disk drive or an optical disk drive. In another embodiment, storage unit 24 includes data distributed across, for example, a local area network (LAN), wide area network (WAN) or a storage area network (SAN) (not shown). It should also be understood that although not shown, additional components, such as cache memory, communication systems, system software, etc., may be incorporated into computer system 12.

In general, computer system 12 is intended to represent any type of computerized system that contains computer programs and is accessed by user 26 to perform personal and/or professional tasks. For example, computer system 12 could represent a personal computer, workstation, laptop, hand held device, etc. To this extent, computer system 12 could represent a stand-alone or network-based computerized system. In the case of the latter, user 26 could directly operate a computerized “user system” (not shown) that communicates with computer system 12. Such communication could occur via a direct hardwired connection (e.g., serial port), or via an addressable connection in a client-server (or server-server) environment that may utilize any combination of wireline and/or wireless transmission methods. In the case of an addressable connection, the server and client may be connected via the Internet, a wide area network (WAN), a local area network (LAN), a virtual private network (VPN) or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

Also shown in FIG. 1 are other users 28 that communicate with computer system 12 over network 30. Other users 28 are intended to represent individuals or groups of individuals who interact with user 26 remotely. For example, other users 28 could represent user 26's electronic mailing partners, chat partners, etc. As such, network 30 is intended to represent any type of network such as a LAN, a WAN, a VPN, the Internet, etc.

Shown in memory 16 of computer system 12 is security system 34, which includes zone definition system 36 and insertion limitation system 38. In general, security system 34 is used to define one or more isolation zones that each include at least one local computer program, and to limit the insertion of content between the isolation zones. As indicated above, computer programs 40A-N are intended to represent any type of computer program. For example, one or more of computer programs 40A-N could be application programs such as a word processing programs, an electronic mailing program, etc. In a typical embodiment, security system 34 is part of, or an addition to operating system 32. For example, security system 34 could be an integral part of operating system 32. Alternatively, security system 34 could work in conjunction with operating system 32 (e.g., similar to the manner in which a “spam stopping” program works in conjunction with an electronic mailing program). It should be appreciated, however, that this need not be the case and that security system 34 could be configured to exist and operate independent of operating system 32.

Under the present invention, zone definition system 36 allow one or more isolation zones to be defined. An isolation zone is defined by grouping/assigning at least one computer program together. To this extent, the definition of an isolation zone can be performed automatically by logic within zone definition system 36 based on a historical behavior of user 26, or manually by user 26 (or an administrator, not shown). In the case of the former, zone definition system 36 could track user 26's workflow to determine which computer programs user 26 tends to use together. For example, user 26 might have a personal workflow sequence in which he/she captures an image from a browser, inserts it into a graphics editor, processes the image using the graphics editor, saves the processed image to a predetermined location, and then inserts (e.g., attaches) the image into an electronic mail message. Based on this workflow, zone definition system 36 could assign/group the browser, graphics editor and the electronic mailing computer programs into a single isolation zone (e.g., isolation zone “A”). Under this methodology, zone definition system 36 could require that a particular workflow be followed with some level of statistical significance before an isolation zone is defined. For example, a particular workflow might need to be followed multiple times before zone definition system 36 will define its computer programs as an isolation zone. In any event, when automatically defining isolation zones, user 26's workflows could be tracked and stored in storage unit 24. For example, as user 26 interacts with a set of computer programs during a workflow, zone definition system could record the set of computer programs in storage unit. Thus, storage unit 24 could contain a historical behavior of user 26. Based on the historical behavior, zone definition system 36 would then automatically define isolations zones as appropriate.

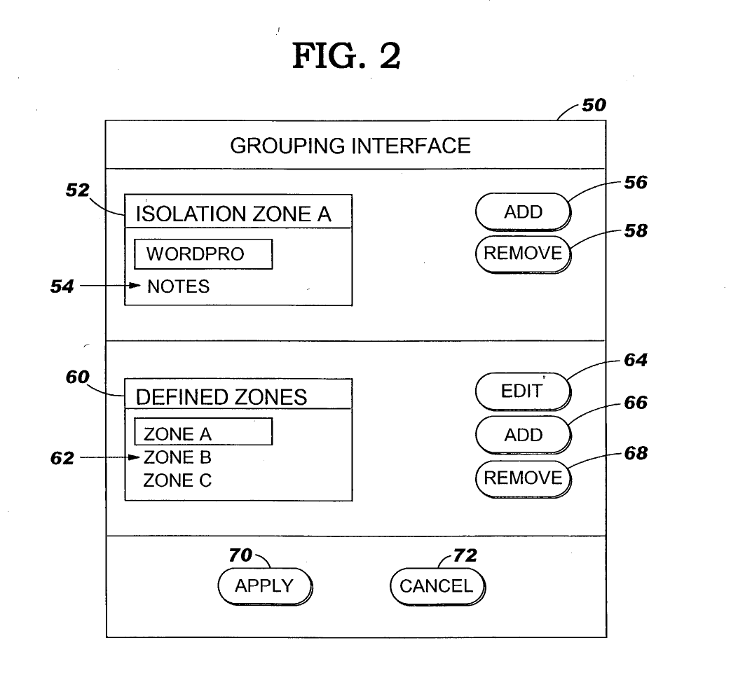

As indicated above, an isolation zone can be defined manually as well. When manually defining an isolation zone, several alternatives are possible. In one embodiment, a grouping interface can be used. Referring to FIG. 2, an illustrative grouping interface 50 is depicted. As shown, grouping interface 50 generally includes program window 52 and defined zone window 60. Defined zone window 60 lists all currently defined isolation zones 62 for computer system 12. As depicted, isolation zones “A-C” have been defined. To edit an existing isolation zone, user 26 could select the particular zone (e.g., isolation zone “A”) within defined zone window 60 and then select edit button 64. After such a selection, program window 52 would list the computer programs 54 that have been assigned to that zone. As shown in the illustrative embodiment of FIG. 2, isolation zone “A” includes the computer programs of WORDPRO and NOTES. If user 26 wishes to add a computer program to isolation zone “A,” he/she could do so by selecting add button 56 and then browsing for the desired computer program. Alternatively, if user 26 wishes to remove a computer program from isolation zone “A,” he/she would select the particular computer program within program window 52 and then select remove button 58. If user 26 wishes to define a new isolation zone, he/she would select add button 66 proximate to defined zone window 60. Once the new isolation zone was added, user 26 would add the desired computer programs to the new isolation zone using program window 52 and add button 56. Alternatively, if user 26 wishes to delete an isolation zone, he/she would select the applicable isolation zone in defined zone window 60 and then select remove button 68. Once any desired changes have been made, user 26 could select apply button 70 to apply the changes, or cancel button 72 to cancel the changes.

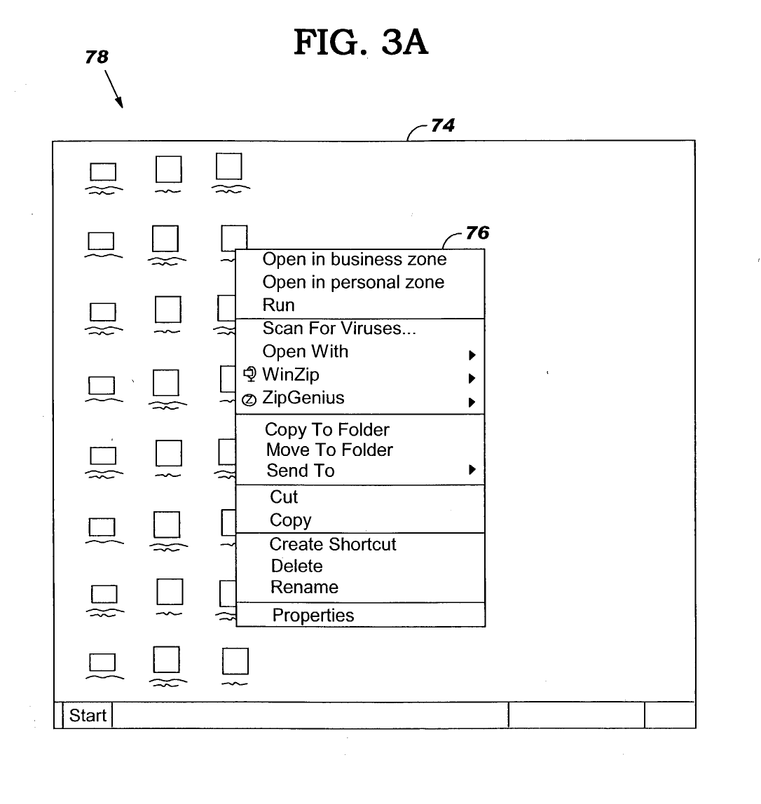

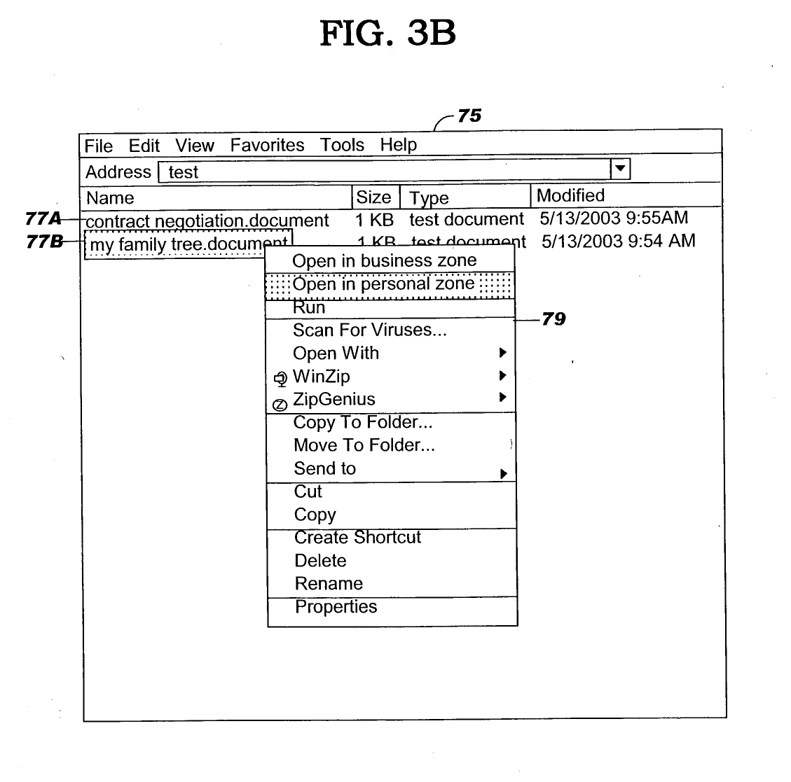

In another embodiment, user 26 could manually assign one or more programs to an isolation zone by manipulating icons corresponding to the computer programs. Referring to FIG. 3A, an illustrative desktop 74 of icons 78 is shown. In this embodiment, user 26 could assign a particular program to an isolation zone by manipulating its corresponding desktop icon. For example, user 26 could “click” a specific mouse button (e.g., the right) on an icon. Then, using the displayed menu 76, user 26 could assign the computer program corresponding to that icon to an isolation zone. In yet another embodiment, individual files could be assigned to an isolation zone. Referring to FIG. 3B a file interface 75 is shown. As depicted, file interface 75 lists files 77A-B. By manipulating a particular file within file interface 75 (e.g., by right-clicking on its listing), a menu 79 similar to that of FIG. 3A could be displayed. Using this menu 79, user 26 could assign the particular file to an isolation zone. Accordingly, the present invention not only allows computer programs as a whole to be assigned to one or more isolation zones, but individual files can be assigned as well.

Regardless of the “assignment” method used, once one or more isolation zones have been defined, insert limitation system 38 (FIG. 1) will limit the insertion of content across an isolation zone boundary (e.g., from one isolation zone into another isolation zone). Specifically, as will be further described below, user 26 will be permitted to freely insert content between computer programs and/or files within the same zone. For example, user 26 would be permitted to copy and paste content from a WORDPRO document into a NOTES electronic mailing message because both are part of isolation zone “A.” However, if user 26 attempts to copy and paste content from a source computer program in isolation zone “A” into a target computer program in isolation zone “B,” insertion limitation system 38 will display a security prompt before pasting the content.

It should be understood that under the present invention, the same computer program or file could be part of multiple isolation zones. For example, isolation zone “A” could include WORDPRO and NOTES, while isolation zone “B” could include FREELANCE and NOTES. To this extent, zone definition system 36 further allows computer programs to be “segmented” as appropriate so that a certain segment of a program can be part of one isolation zone, while another segment can be part of another isolation zone. For example, an electronic mailing or chat computer program could include one or more lists of contacts (e.g., list “A for friends and list “B” for coworkers). Zone definition system 36 could allow list “A” to be associated with a first isolation zone and list “B” to be associated with a second isolation zone.

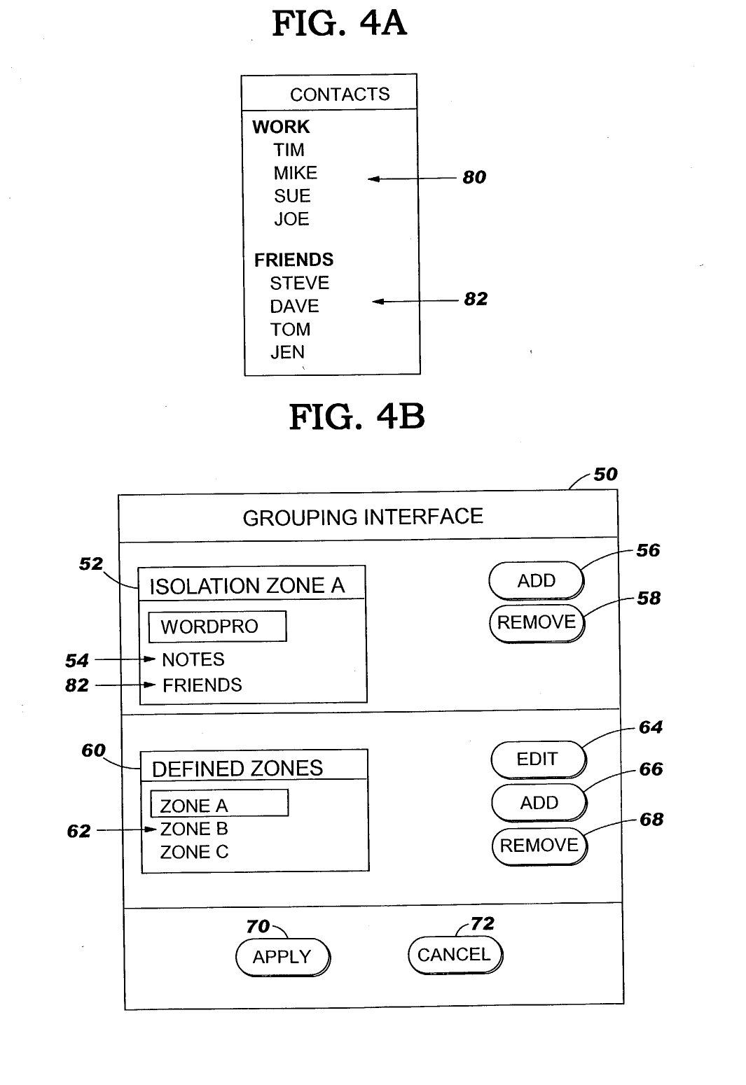

Referring to FIGS. 4A-B, this feature will be explained in grater detail. FIG. 4A depicts exemplary contact lists 80 and 82. In this example, assume that contact lists 80 and 82 exist pursuant to a network-based chat computer program. If user 26 wishes to associate contact list 82 with isolation zone “A,” he/she could do so by selecting zone “A” in defined zone window 60 and then selecting edit button 64. As indicated above, this would cause the computer programs of isolation zone “A” to be listed in program window 52. User 26 could then select add button 56 and add contact list 82 to isolation zone “A” (as shown). Once contact list 82 has been added to isolation zone “A,” user 26 can insert content between the other programs in isolation zone “A” and this contact list. For example, user 26 would be permitted to copy and paste content from a WORDPRO document into a chat window corresponding to contact “Steve.” However, if user 26 attempted to copy and paste the same content into a chat window corresponding to contact “Tim,” insertion limitation system 38 would display a security prompt.

Under the present invention several different types of security prompts could be provided. In one embodiment, the security prompt is a request for confirmation by user 26. Specifically, user 26 could be presented with a pop-up window that asks “Are you sure you want to paste that here?” The pop-up window could include buttons for “Yes” and “No” so that user 26 can confirm or cancel the pasting. In another embodiment, insertion limitation system 38 could present a request for a security credential before allowing the insertion. For example, user 26 could be prompted to input a user name and/or password that must be authenticated before the insertion is permitted. To this extent, the present invention is typically adapted to accommodate any type of security credential. For example, authentication could be based on biometric information. In any event, storage unit 24 could include the necessary security credential information for authentication by insertion limitation system 38. The request for a security credential helps avoid the problems associated with third parties accessing the content stored in the buffer should user 26 not be actively using computer system 12. To this extent, insertion limitation system 38 could also clear the buffer after a predetermined amount of time. Such clearance could coincide with the engagement of a screen saver or the like.

It should be understood that the present invention is not limited to controlling the insertion of content between multiple isolation zones. Rather, the present invention can limit the insertion of content in or out of a single isolation zone. For example, assume that computer system 12 has computer programs “A-Z” loaded thereon. Further assume that only one isolation zone has been defined and it includes computer programs “A-D.” The present invention can provide a security prompt when an attempt is made to insert content from computer program “A” to a computer program not included in isolation zone “A” (e.g., computer program “Z”). Similarly, a security prompt could be provided when an attempt is made to insert content from computer program “Z” to computer program “A.” Accordingly, the present invention can limit the insertion of content across a single isolation zone boundary.

It should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for limiting insertion of content between computer programs, comprising:
defining an isolation zone, wherein the isolation zone comprises at least one computer program; and
providing a security prompt when an attempt is made to insert content across a boundary of the isolation zone.

2. The method of claim 1, wherein the security prompt comprises a confirmation request.

3. The method of claim 1, wherein the security prompt comprises a security credential request.

4. The method of claim 1, wherein the defining step comprises defining the isolation zone by manually assigning at least one computer program to the isolation zone.

5. The method of claim 4, wherein the at least one computer program is manually assigned to the isolation zone using a grouping interface.

6. The method of claim 4, wherein the at least one computer program is manually assigned to the isolation zone by manipulating icons corresponding to the at least one computer program.

7. The method of claim 1, wherein the defining step comprises defining the isolation zone by automatically assigning at least one computer program to the isolation zone based upon a historical behavior of a user.

8. The method of claim 1, further comprising:
selecting content of a source computer program in the isolation zone; and
attempting to insert the content to a target computer program outside of the isolation zone.

9. A method for limiting insertion of content between local computer programs, comprising:
defining a first isolation zone and a second isolation zone, wherein the first isolation zone and the second isolation zone each comprise at least one computer program; and
providing a security prompt when an attempt is made to insert content from a source computer program in the first isolation zone to a target computer program in the second isolation zone.

10. The method of claim 9, further comprising:
selecting the content of the source computer program in the first isolation zone;
inserting the content from the source computer program into a buffer; and
attempting to insert the content from the buffer to the target computer program in the second isolation zone.

11. The method of claim 9, wherein the security prompt comprises a confirmation request.

12. The method of claim 9, wherein the security prompt comprises a security credential request.

13. The method of claim 9, wherein the defining step comprises defining a particular isolation zone by manually assigning at least one computer program to the particular isolation zone.

14. The method of claim 13, wherein the at least one computer program is manually assigned to the particular isolation zone using a grouping interface.

15. The method of claim 13, wherein the at least one computer program is manually assigned to the particular isolation zone by manipulating icons corresponding to the at least one computer program.

16. The method of claim 9, wherein the defining step comprises defining a particular isolation zone by automatically assigning at least one computer program to the particular isolation zone based upon a historical behavior of a user.

17. The method of claim 9, wherein the content is cleared from the buffer after a predetermined period of time.

18. A system for limiting insertion of content between computer programs, comprising:
a zone definition system for defining an isolation zone, wherein the isolation zone comprises at least one computer program; and
an insertion limitation system for providing a security prompt when an attempt is made to insert content across a boundary of the isolation zone.

19. The system of claim 18, wherein the security prompt comprises a confirmation request.

20. The system of claim 18, wherein the security prompt comprises a security credential request.

21. The system of claim 18, wherein the zone definition system defines the isolation zone by manually assigning at least one computer program to the isolation zone.

22. The system of claim 21, wherein the at least one computer program is manually assigned to the isolation zone using a grouping interface.

23. The system of claim 21, wherein the at least one computer program is assigned to the isolation zone by manipulating icons corresponding to the at least one computer program.

24. The system of claim 18, wherein the zone definition system defines the isolation zone by automatically assigning at least one computer program to the isolation zone based upon a historical behavior of a user.

25. A program product stored on a recordable medium for limiting insertion of content between computer programs, which when executed comprises:
program code for defining an isolation zone, wherein the isolation zone comprises at least one computer program; and
program code for providing a security prompt when an attempt is made to insert content across a boundary of the isolation zone.

26. The program product of claim 25, wherein the security prompt comprises a confirmation request.

27. The program product of claim 25, wherein the security prompt comprises a security credential request.

28. The program product of claim 25, wherein the program code for defining defines the isolation zone by manually assigning at least one computer program to the isolation zone.

29. The program product of claim 28, wherein the at least one computer program is manually assigned to the isolation zone using a grouping interface.

30. The program product of claim 28, wherein the at least one computer program is assigned to the isolation zone by manipulating icons corresponding to the at least one computer program.

31. The program product of claim 25, wherein the program code for defining defines the isolation zone by automatically assigning at least one computer program to the isolation zone based upon a historical behavior of a user.
